(19) United States
(12) Patent Application Publication
(10) Pub. No.: US 2022/0005203 A1
(43) Pub. Date: Jan. 6, 2022

(54) IMAGE PROCESSING METHOD AND IMAGE PROCESSING DEVICE

(71) Applicant: NEC Corporation, Minato-ku, Tokyo (JP)

(72) Inventors: Ryuichi AKASHI, Tokyo (JP); Keiichi CHONO, Tokyo (JP); Masato TSUKADA, Tokyo (JP); Chisato FUNAYAMA, Tokyo (JP); Takahiro TOIZUMI, Tokyo (JP); Yuka OGINO, Tokyo (JP)

(73) Assignee: NEC Corporation, Minato-ku, Tokyo (JP)

(21) Appl. No.: 17/294,071

(22) PCT Filed: Nov. 19, 2018
(86) PCT No.: PCT/JP2018/042673

§ 371 Date: May 14, 2021

(51) Int. Cl. G06T 7/194; G06T 7/174; G06T 7/13; G06T 7/11; G06T 7/55; G06T 7/73

(52) U.S. Cl. CPC G06T 7/194; G06T 7/174; G06T 7/13; G06T 2207/10004; G06T 7/55; G06T 7/75; G06T 2207/10028; G06T 7/11

(57) ABSTRACT

In order to detect the foreground without being affected by reflected light from the shadow of an object or the background and so on, in both indoor and outdoor environments, the image processing method includes a step of generating first foreground likelihood from a visible light image, a step of generating second foreground likelihood from a depth image in which the same object is captured as that in the visible light image, a step of generating reliability of the depth image using at least the visible light image and the depth image, and a step of determining foreground likelihood of the object based on the first foreground likelihood and the second foreground likelihood, using the reliability of the depth image as a weight.

### TECHNICAL FIELD

The present invention relates to an image processing method and an image processing device for detecting a foreground from an input image.

### BACKGROUND ART

A method called background subtraction is known to extract target objects from an image. The background subtraction is a method of extracting target objects that do not exist in a background image by comparing the previously acquired background image with the observed image. The region occupied by the object that does not exist in the background image (the region occupied by the target object) is called the foreground region, and the other region is called the background region.

Patent literature 1 describes an object detection device that uses background differences to detect the state of the foreground (target object) relative to the background (background object). Specifically, as shown in FIG. 14, in an object detection device 50, a projection unit (light source) 51 emitting near infrared light irradiates light on the region (irradiation region) where the target object exists. A ranging unit 52, which receives the near infrared light, receives the reflected light from the irradiated region of the light emitted from the projection unit 51 under an exposure condition suitable for the background. The ranging unit 52 generates a background depth map by measuring the distance based on the received light. The ranging unit 52 receives the reflected light from the illuminated region of the light emitted from the projection unit 51 under an exposure condition suitable for the foreground. The ranging unit 52 generates a foreground depth map by measuring the distance based on the received light.

The state determination unit 53 calculates a difference between the background depth map and the foreground depth map. Then, the state determination unit 53 detects a state of the foreground based on the difference.

When a visible light camera is used in the ranging unit 52, a shadow of an object or reflected light from a background surface such as a floor may cause a false detection of the target object. However, by using a near infrared light camera in the ranging unit 52, influence of shadows of an object and the like is reduced.

However, near infrared light is also contained in sunlight. Therefore, an object detection device using a near infrared light camera (near infrared camera) cannot measure distances accurately due to influence of sunlight. In other words, an object detection device such as it described in patent literature 1 are not suitable for outdoor use.

Non-patent literature 1 describes an image processing device that uses a solar spectrum model. Specifically, as shown in FIG. 15, in the image processing device 60, the date and time specification unit 61 specifies the date and time used to calculate the solar spectrum. The position specification unit 62 specifies the position used for the calculation of the solar spectrum.

The solar spectrum calculation unit 63 calculates the solar spectrum using the date and time input from the date and time specification unit 61 and the position input from the position specification unit 62 by using a sunlight model. The solar spectrum calculation unit 63 outputs the signal including the solar spectrum to the estimated-background calculation unit 64.

The estimated-background calculation unit 64 also receives a signal (input image signal) Vᵢₙ including an input image (RGB image) captured outdoors. The estimated-background calculation unit 64 calculates an estimated background using the color information of the input image and the solar spectrum. The estimated background refers to the image that is predicted to be closest to the actual background. The estimated-background calculation unit 64 outputs the estimated background to the estimated-background output unit 65. The estimated-background output unit 65 may output the estimated background as it is as Vₒᵤₜ, or it may output foreground likelihood.

When outputting the foreground likelihood, the estimated-background output unit 65 obtains the foreground likelihood based on a difference between the estimated background and the input image signal, for example.

The image processing device 60 can obtain the estimated background or foreground likelihood from an input image captured outdoors. However, it is difficult for the image processing device 60 to obtain the foreground likelihood from an input image captured indoors. This is because the illumination light spectrum is unknown, although it is possible to calculate the indoor illumination light spectrum instead of calculating the solar spectrum when the image processing device 60 is used indoors.

### CITATION LIST

### Patent Literature

Patent literature 1: Japanese Patent Laid-Open No. 2017-125764 Non-Patent Literature

Non-Patent literature 1: A. Sato, et al., “Foreground Detection Robust Against Cast Shadows in Outdoor Daytime Environment”, ICIAP 2015, Part II, LNCS 9280, pp. 653-664, 2015

### SUMMARY OF INVENTION

### Technical Problem

As explained above, there are technologies for detecting the foreground with high accuracy in indoor environment and for detecting the foreground with high accuracy in outdoor environment, separately. However, the devices described in patent literature 1 and non-patent literature 1 cannot accurately detect the foreground in both indoor and outdoor environments.

It is an object of the present invention to provide an image processing method and an image processing device that can detect the foreground without being affected by reflected light from the shadow of an object or the background and so on, in both indoor and outdoor environments.

### Solution to Problem

An image processing method according to the present invention includes generating first foreground likelihood from a visible light image, generating second foreground likelihood from a depth image in which the same object is captured as that in the visible light image, generating reliability of the depth image using at least the visible light image and the depth image, and determining foreground likelihood of the object based on the first foreground likelihood and the second foreground likelihood, using the reliability of the depth image as a weight.

An image processing device according to the present invention includes first likelihood generation means for generating first foreground likelihood from a visible light image, second likelihood generation means for generating second foreground likelihood from a depth image in which the same object is captured as that in the visible light image, depth reliability generation means for generating reliability of the depth image using at least the visible light image and the depth image, and foreground detection means for determining foreground likelihood of the object based on the first foreground likelihood and the second foreground likelihood, using the reliability of the depth image as a weight.

An image processing program according to the present invention causes a computer to execute a process of generating first foreground likelihood from a visible light image, a process of generating second foreground likelihood from a depth image in which the same object is captured as that in the visible light image, a process of generating reliability of the depth image using at least the visible light image and the depth image, and a process of determining foreground likelihood of the object based on the first foreground likelihood and the second foreground likelihood, using the reliability of the depth image as a weight.

### Advantageous Effects of Invention

According to this invention, the foreground can be detected in both indoor and outdoor environments without being affected by shadows of objects or reflected light from the background.

### BRIEF DESCRIPTION OF DRAWINGS

FIG. 1 It depicts a block diagram showing an example of a configuration of an image processing device of the first example embodiment.

FIG. 2 It depicts a block diagram showing an example of a configuration of a depth reliability generation unit in the first example embodiment.

FIG. 3 It depicts a flowchart showing an operation of the image processing device of the first example embodiment.

FIG. 4 It depicts an explanatory diagram of direct light from the sun and ambient light.

FIG. 5 It depicts an explanatory diagram of a foreground likelihood generating method.

FIG. 6 It depicts a block diagram showing an example of a configuration of an image processing device of the second example embodiment.

FIG. 7 It depicts a block diagram showing an example of a configuration of a depth reliability generation unit in the second example embodiment.

FIG. 8 It depicts a flowchart showing an operation of the image processing device of the second example embodiment.

FIG. 9 It depicts a block diagram shows an example of a configuration of an image processing device of the third example embodiment.

FIG. 10 It depicts a block diagram showing an example of a configuration of a depth reliability generation unit in the third example embodiment.

FIG. 11 It depicts a flowchart showing an operation of the image processing device of the third example embodiment.

FIG. 12 It depicts a block diagram of an example of a computer including a CPU.

FIG. 13 It depicts a block diagram of the main part of an image processing device.

FIG. 14 It depicts a block diagram of an object detection device.

FIG. 15 It depicts a block diagram showing an image processing device described in the non-patent literature 1.

### DESCRIPTION OF EMBODIMENTS

Hereinafter, example embodiments of the present invention will be described with reference to the drawings.

### EXAMPLE EMBODIMENT 1

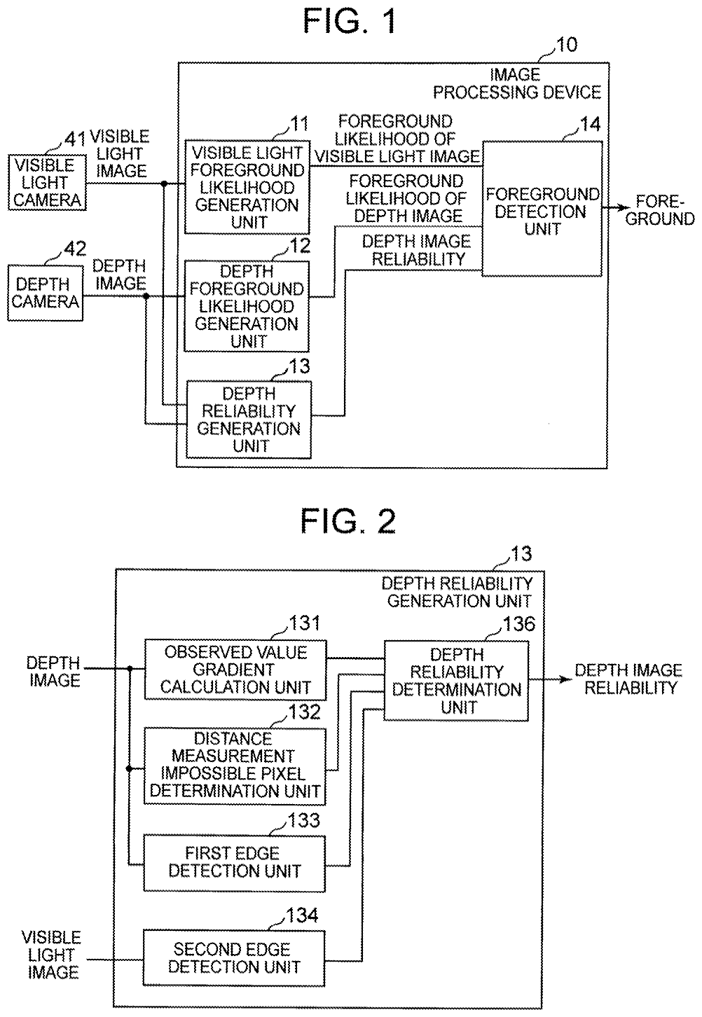

FIG. 1 shows a block diagram of an example configuration of the first example embodiment of an image processing device. In the example shown in FIG. 1, the image processing device 10 has a visible light foreground likelihood generation unit 11, a depth foreground likelihood generation unit 12, a depth reliability generation unit 13, and a foreground detection unit 14.

The visible light foreground likelihood generation unit 11 generates foreground likelihood of a visible light image for each predetermined region in the frame from at least a frame of a visible light image. The depth foreground likelihood generation unit 12 generates foreground likelihood of a depth image for each predetermined region in the frame from at least a depth image (an image in which the depth value (distance) is expressed in light and shade) of the frame. The depth reliability generation unit 13 generates a depth image reliability for each predetermined region from at least a frame of the depth image. The foreground detection unit 14 detects the foreground from which influence of shadows of an object and reflection from the object is excluded based on the foreground likelihood of the visible light image, the foreground likelihood of the depth image and the depth image reliability.

In this example embodiment, a visible light image is obtained by general visible light image acquisition means (for example, visible light camera 41). The depth image (distance image) is obtained by distance image acquisition means (for example, depth camera 42), such as a ToF (Time of Flight) camera that uses near infrared light. However, devices for obtaining the visible light image and the depth image are not limited to those. For example, a ToF camera that also has a function to obtain a visible light image may be used.

The image processing device 10 may input a visible light image that is stored in a memory unit (not shown) in advance. The image processing device 10 may also input a depth image that is stored in a memory unit (not shown) in advance.

FIG. 2 shows a block diagram showing an example of a configuration of a depth reliability generation unit 13. In the example shown in FIG. 2, the depth reliability generation unit 13 comprises an observed value gradient calculation unit 131, a distance measurement impossible pixel determination unit 132, a first edge detection unit 133, a second edge detection unit 134, and a depth reliability determination unit 136.

The observed value gradient calculation unit 131 calculates gradient of the observed value for each small region in the depth image in which the same object is captured as that in the visible light image. The size of the small region is arbitrary. For example, the size of a small region is 5×5 pixels. The distance measurement impossible pixel determination unit 132 determines whether each pixel in the depth image is distance measurement impossible (range impossible: distance cannot be obtained) for each small region. The first edge detection unit 133 detects the edges in the depth image for each small region. The second edge detection unit 134 detects edges in visible light image for each small region. The depth reliability determination unit 136 determines depth image reliability using the gradient of the observed values, the distance measurement impossible pixels, the edges in the depth image and the edges in the visible light image.

In this example embodiment, the depth reliability determination unit 136 uses information regarding the gradient of the observed values, the distance measurement impossible pixels, the edges in the depth image and the edges in the visible light image, but the depth reliability determination unit 136 may use some of that information. The depth reliability determination unit 136 may also use other information in addition to the information.

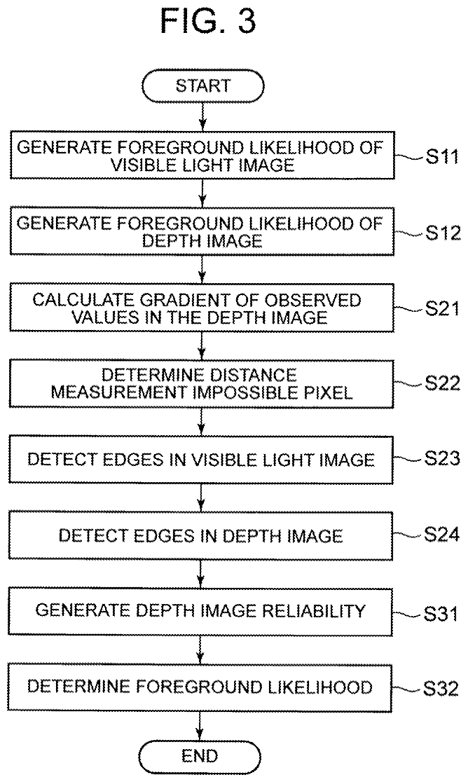

Next, the operation of the image processing device 10 will be explained with reference to the flowchart in FIG. 3.

The visible light foreground likelihood generation unit 11 generates foreground likelihood of the visible light image using a solar spectrum model (step S11). The visible light foreground likelihood generation unit 11 can generate the foreground likelihood in various ways. For example, the visible light foreground likelihood generation unit 11 uses the method described in the non-patent literature 1.

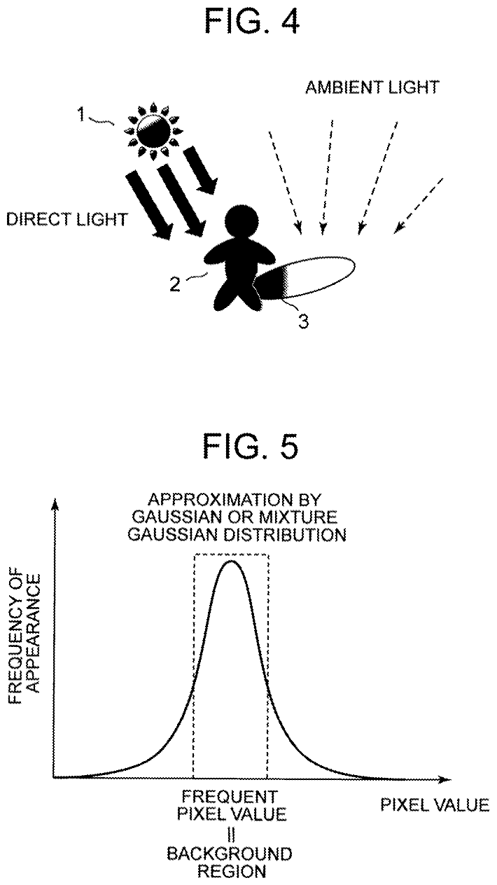

FIG. 4 illustrates an explanatory diagram of direct light from the sun 1 and ambient light. FIG. 4 also shows an object (for example, a person) 2 as foreground and a shadow 3 of object 2 caused by the direct light.

The visible light foreground likelihood generation unit 11 first calculates spectrum of solar light (direct light and ambient light) at the shooting position and shooting time of the camera. The visible light foreground likelihood generation unit 11 converts the spectrum into color information. The color information is, for example, information of each channel in the RGB color space. The color information is expressed as in equation (1).

[Math. 1]

direct light:I_{d}^{c} ambient light:I_{B}^{C} (1)[Math. 1]

The pixel values (for example, RGB values) of the direct light and the ambient light are expressed as follows. In equation (2), p, q, and r are coefficients that represent the intensity of the direct light or the ambient light. Hereinafter, pixel values are assumed to be RGB values in the RGB color space. In that case, the superscript c in equations (1) and (2) represents one of R-value, G-value, or B-value.

[Math. 2]

direct light:L_{d}^{c}=p·I_{d}^{c} ambient light:Lₛ^{c}=q·I_{d}^{c}+r·Iₛ^{c} (2)

The visible light foreground likelihood generation unit 11 calculates an estimated background from the input visible light image (in this example, RGB image) and the solar spectrum. Assuming that the RGB value of the background in the visible light image is B, the estimated background can be expressed as follows.

$$[ Math . 3 ]$$

$${B}_{sh}^{c} = \frac{{L}_{s}^{c}}{{L}_{d}^{c} + {L}_{s}^{c}} \cdot {B}^{c} = \frac{{qI}_{d}^{c} + {rI}_{s}^{c}}{( p + q ) {I}_{d}^{c} + {rI}_{s}^{c}} \cdot {B}^{c} = \frac{{nI}_{d}^{c} + {I}_{s}^{c}}{{mI}_{d}^{c} + {I}_{s}^{c}} \cdot {B}^{c} \qquad ( 3 )$$

In equation (3), m=(p+q)/1 and n=q/1. When the RGB value of the input visible light image is Cᵢ, the visible light foreground likelihood generation unit 11 obtains m and n that minimize the difference between Cᵢ and B_{c}. The visible light foreground likelihood generation unit 11 substitutes the obtained m and n into the equation (3) to obtain the RGB values of the estimated background image.

Then, the visible light foreground likelihood generation unit 11 regards the difference between normalized RGB values Cᵢ of the visible light image and normalized RGB values of the estimated background image as the foreground likelihood. The visible light foreground likelihood generation unit 11 may use a value that has been processed in some way for the difference as the foreground likelihood.

The depth foreground likelihood generation unit 12 generates the foreground likelihood (foreground likelihood of the depth image) for each pixel in the depth image (step S12). FIG. 5

shows an explanatory diagram of a foreground likelihood generating method. The depth foreground likelihood generation unit 12 creates a histogram of pixel values (luminance values) for each pixel in the depth images of multiple frames in the past, in order to generate the foreground likelihood of a depth image. Since the background is stationary, positions where similar pixel values appear over multiple frames are likely to be included in the background. Since the foreground may move, positions where pixel values vary over multiple frames are likely to be included in the foreground.

The depth foreground likelihood generation unit 12 approximates the histogram of pixel values with a Gaussian or mixture d Gaussian distribution, and derives the foreground likelihood from the Gaussian or mixture Gaussian distribution.

It is noted that such generation of a foreground likelihood is just one example, and the depth foreground likelihood generation unit 12 can use various known methods of generating a foreground likelihood.

Next, the depth reliability generation unit 13 generates depth image reliability in step S31 after performing processes of steps S21 to S24.

In the depth reliability generation unit 13, the observed value gradient calculation unit 131 calculates gradient of the observed value (luminance value) of pixels for each small region in the depth image (step S21). The distance measurement impossible pixel determination unit 132 determines whether or not each pixel is a distance measurement impossible pixel for each small region (step S22). For example, the distance measurement impossible pixel determination unit 132 assumes that a pixel with a pixel value of 0 is a distance measurement impossible pixel. As the pixel value of 0 corresponds to the matter that no reflected light of near infrared light is obtained, the distance measurement impossible pixel determination unit 132 considers the pixel with the pixel value of 0 to be a distance measurement impossible pixel.

The first edge detection unit 133 detects edges for each small region in the depth image (step S23). The second edge detection unit 134 detects edges for each small region in the visible light image (step S24).

The depth reliability determination unit 136 determines a depth image reliability (step S31), for example, as follows.

The depth reliability determination unit 136 assigns higher reliability to regions with a smaller gradient of observed values. A small gradient of observed values corresponds to a small spatial distance difference (it means smooth) in the depth image. Since a smooth region is considered to be a stable region where the distance can be observed without being affected by a shadow of an object or a reflected light, the depth reliability determination unit 136 assigns a high reliability to this region.

The depth reliability determination unit 136 assigns lower reliability to a region consisting of distance measurement impossible pixels.

In addition, when there is a region where positions of edges in the depth image share positions of edges in the visible light image in common, the depth reliability determination unit 136 assigns higher reliability to the region.

An edge is a portion where the gradient of the observed values exceeds a predetermined threshold, but it is also a portion with a large amount of noise. However, when edges exist in a depth image at the same region where edges also exist in a visible light image, the edge in the depth image is not a false edge formed by noise. In other words, by referring to the edge in the visible light image, the depth reliability determination unit 136 increases the reliability of the portion of the depth image that is determined to be an edge.

When edges do not exist in the visible light image in the region where edges exist in the depth image, the depth reliability determination unit 136 assigns lower reliability to the region where the edges exist in the depth image.

The depth reliability determination unit 136 can conveniently set “1” (the maximum value) as a high reliability and “0” (the minimum value) as a low reliability. However, the depth reliability determination unit 136 can set a reliability that depends on the primary operating environment of the image processing device 10 and other factors.

The higher reliability assigned to the depth image means that the foreground in the depth image is reflected more strongly in the final determined foreground or foreground likelihood than the foreground in the visible light image.

The depth reliability determination unit 136 may assign a reliability of “0” or close to 0 to the region consisting of distance measurement impossible pixels, and assign a reliability of normalized cross-correlation between the region in the visible light image and the region in the depth image to the other regions (regions containing pixels other than distance measurement impossible pixels). In this case, the cross-correlation between the visible light image and the depth image is used as the reliability.

The foreground detection unit 14 determines the foreground or foreground likelihood (final foreground likelihood) (step S32). The foreground detection unit 14 uses the foreground likelihood of the visible light image generated by the visible light foreground likelihood generation unit 11, the foreground likelihood of the depth image generated by the depth foreground likelihood generation unit 12, and the depth image reliability generated by the depth reliability generation unit 13, as described below.

It is assumed that the foreground likelihood of the visible light image is Pᵥ(x,y), the foreground likelihood of the depth image is P_{d}(x,y), and the depth image reliability is S(x,y). x denotes the x-coordinate value, and y denotes the y-coordinate value.

The foreground detection unit 14 determines the final foreground likelihood P(x,y) using the following equation (4).

P(x,y)={1−S(x,y)_{}·Pv}(x,y)+S(x,y)·Pd(x,y) (4)

The foreground detection unit 14 may determine the foreground region by binarizing the foreground likelihood P(x,y) and output the foreground. The binarization is a process in which, for example, pixels with pixel values that exceed a predetermined threshold are considered to be foreground pixels.

Although a flowchart in which each step is executed sequentially is shown in FIG. 3, the image processing device 10 may execute the process of step S11, the process of step S12, and the process of steps S21 to S24 in parallel. In addition, the depth reliability generation unit 13 may execute each of the processes of steps S21 to S24 in parallel.

As explained above, in this example embodiment, in the image processing device 10, the visible light foreground likelihood generation unit 11 generates the foreground likelihood of the visible light image using a solar spectrum model, the depth foreground likelihood generation unit 12 generates the foreground likelihood of the depth image, and the depth reliability generation unit 13 generates reliability (depth image reliability) of the foreground likelihood of the depth image. Since the foreground detection unit 14 determines the final foreground likelihood based on the foreground likelihood of the visible light image and the foreground likelihood of the depth image, using the depth image reliability as a weight, it is possible to detect the foreground without being affected by a shadow of an object or a reflected light in both indoor and outdoor environments.

### EXAMPLE EMBODIMENT 2

The image processing device 10 of the first example embodiment compares the edges in the visible light image with the edges in the depth image, but in the second example embodiment, the image processing device compares the edges in the visible light image with the edges in the near infrared image.

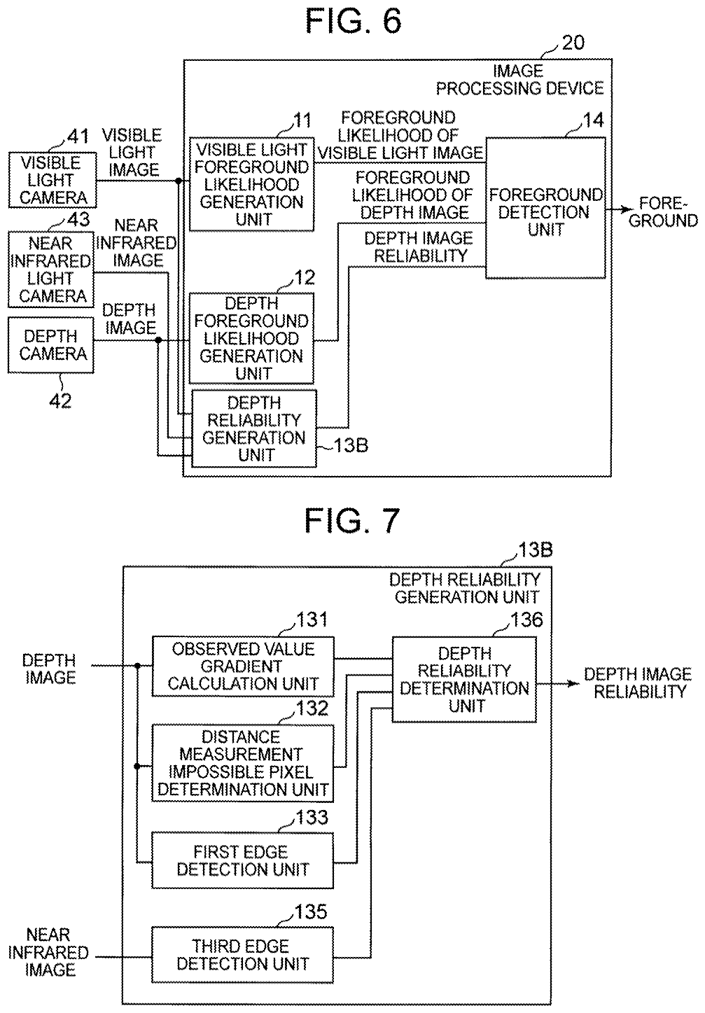

FIG. 6 shows a block diagram of an example configuration of the second example embodiment of an image processing device.

In the image processing device 20 shown in FIG. 6, the depth reliability generation unit 13B also inputs near infrared images from near infrared image acquisition means (for example, near infrared light camera 43). The depth reliability generation unit 13B compares the edges in the visible light image with the edges in the near infrared image. The other configuration of the image processing device 20 is the same as that of the image processing device 10.

The image processing device 20 may input a near infrared image that is stored in a memory unit (not shown) in advance.

FIG. 7 is a block diagram showing an example of a configuration of a depth reliability generation unit 13B. In the example shown in FIG. 7, the third edge detection unit 135 in the depth reliability generation unit 13B detects edges in a near infrared image in which the same object is captured as that inf the depth image. The other configuration of the depth reliability generation unit 13B is the same as that of the depth reliability generation unit 13.

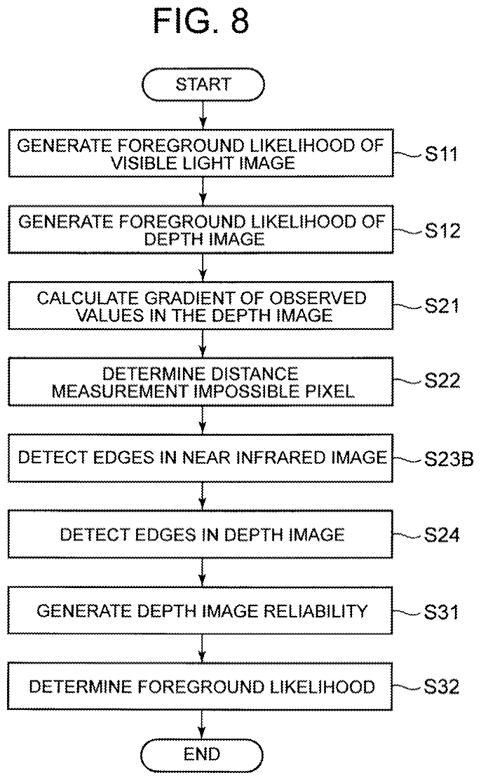

FIG. 8 is a flowchart showing an operation of the image processing device 20 of the second example embodiment.

The third edge detection unit 135 detects edges for each small region in the near infrared image (step S23B). The process of step S23 (see FIG. 3) is not performed. The other processing of the image processing device 20 is the same as the processing in the first example embodiment. However, the depth reliability determination unit 136 compares the edge position in the depth image with the edge position in the near infrared image when assigning a reliability based on the edge position.

Although a flowchart in which each step is executed sequentially is shown in FIG. 8, the image processing device 20 may execute the process of step S11, the process of step S12, and the processes of steps S21 to S24 in parallel. In addition, the depth reliability generation unit 13B may execute each of the processes of steps S21, S22, S23B, and S24 in parallel.

In this example embodiment, in the image processing device 10, the visible light foreground likelihood generation unit 11 generates the foreground likelihood of the visible light image using the solar spectrum model, the depth foreground likelihood generation unit 12 generates the foreground likelihood of the depth image, and the depth reliability generation unit 13B generates reliability (depth image reliability) of the foreground likelihood of the depth image. Since the foreground detection unit 14 determines the final foreground likelihood based on the foreground likelihood of the visible light image and the foreground likelihood of the depth image using the depth image reliability as a weight, it is possible to detect the foreground without being affected by a shadow of an object or a reflected light in both indoor and outdoor environments. In addition, since this example embodiment uses edge positions in the near infrared image when assigning reliability based on edge positions, it is expected to improve the accuracy of reliability based on edge positions in dark indoor environment.

In this example embodiment, the near infrared light camera 43 is provided separately from the depth camera 42, but if a camera that receives near infrared light is used as the depth camera 42, the depth reliability generation unit 13B may detect edges from an image from the depth camera 42 (an image obtained by receiving near infrared light for a predetermined exposure time). In that case, the near infrared light camera 43 is not necessary.

### EXAMPLE EMBODIMENT 3

The image processing device 10 of the first example embodiment compared the edges in the depth image with the edges in the visible light image, and the image processing device 20 of the second example embodiment compared the edges in the depth image with the edges in the near infrared image, but in the third example embodiment, the image processing device compares the edges in the depth image is compared with the edges in the visible light image and the edges in the near infrared image.

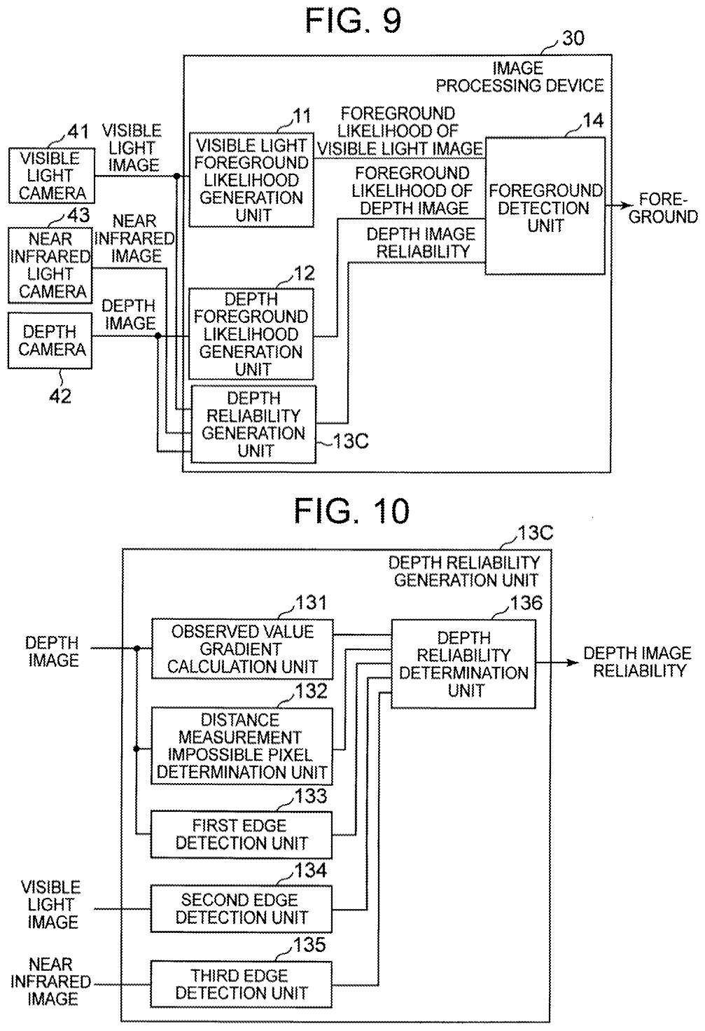

FIG. 9 shows a block diagram of an example configuration of the third example embodiment of an image processing device.

In the image processing device 30 shown in FIG. 9, the depth reliability generation unit 13C also inputs a near infrared image from the near infrared light camera 43. The depth reliability generation unit 13C compares the edges in the depth image with the edges in the visible light image and the edges in the near infrared image. The other configuration of the image processing device 30 is the same as that of the image processing device 10.

The image processing device 30 may input a near infrared image that has been previously stored in a memory unit (not shown).

FIG. 10 is a block diagram of an example configuration of the depth reliability generation unit 13C. In the example shown in FIG. 10, the third edge detection unit 135 in the depth reliability generation unit 13C detects edges in the near infrared image in which the same object is captured as that in the depth image. The rest of the configuration of the depth reliability generation unit 13C is the same as that of the depth reliability generation unit 13.

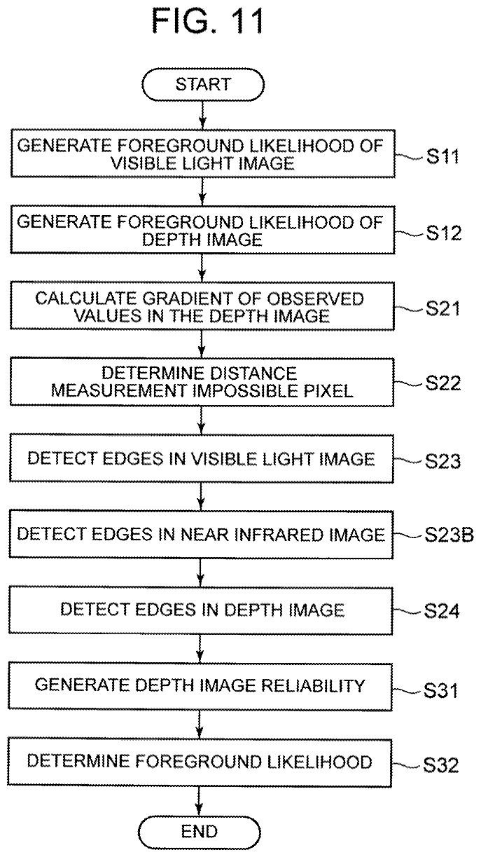

FIG. 11 is a flowchart showing an operation of the image processing device 30 of the third example embodiment.

The third edge detection unit 135 performs the process of step S23 and also detects edges for each small region in the near infrared image (step S23B). The other processing of the image processing device 30 is the same as the processing in the first example embodiment.

However, the depth reliability determination unit 136 compares the edge positions in the depth image with the edge positions in the near infrared image when assigning a reliability based on edge positions.

When there is a region where positions of edges in the depth image share positions of edges in the visible light image in common, further share positions of edges in the near infrared image in common, the depth reliability determination unit 136 assigns higher reliability to the region.

Alternatively, when there is a region where positions of edges in the depth image share positions of edges in the visible light image in common, the depth reliability determination unit 136 may assign a high reliability to the region in the depth image, in addition, when there is a region where positions of edges in the depth image share positions of edges in the near infrared image in common, the depth reliability determination unit 136 may assign a high reliability to the region in the depth image.

Although a flowchart in which each step is executed sequentially is shown in FIG. 11, the image processing device 30 is capable of executing the process of step S11, the process of step S12, and the processes of steps S21 to S24 in parallel. Also, the depth reliability generation unit 13B is capable of executing each of the processes of steps S21 to S24 in parallel.

In this example embodiment, in the image processing device 10, the visible light foreground likelihood generation unit 11 generates the foreground likelihood of the visible light image using the solar spectrum model, the depth foreground likelihood generation unit 12 generates the foreground likelihood of the depth image, and the depth reliability generation unit 13C generates reliability (depth image reliability) of the foreground likelihood of the depth image. Then, the foreground detection unit 14 generates the foreground likelihood. Then, the foreground detection unit 14 determines the final foreground likelihood based on the foreground likelihood of the visible light image and the foreground likelihood of the depth image using the depth image reliability as a weight, making it possible to detect the foreground without being affected by shadows of objects or reflected light in both indoor and outdoor environments. In addition, since this example embodiment uses edge positions in near infrared images when assigning reliability based on edge positions, it is expected to improve the accuracy of reliability based on edge positions in dark indoor environments.

In this example embodiment, the near infrared light camera 43 is provided separately from the depth camera 42, but if a camera that receives near infrared light is used as the depth camera 42, the depth reliability generation unit 13B may detect edges from an image from the depth camera 42 (an image obtained by receiving near infrared light for a predetermined exposure time). In that case, the near infrared light camera 43 is not necessary. In each of the above example embodiments, the image processing devices 10, 20, and 30 performed gradient detection, distance measurement impossible pixel determination, and edge detection for each small region in the image, but they may also perform gradient detection, distance measurement impossible pixel determination, and edge detection for the entire frame.

Although the components in the above example embodiment may be configured with a piece of hardware or a piece of software. Alternatively, the components may be configured with a plurality of pieces of hardware or a plurality of pieces of software. Further, part of the components may be configured with hardware and the other part with software.

The functions (processes) in the above example embodiments may be realized by a computer having a processor such as a central processing unit (CPU), a memory, etc. For example, a program for performing the method (processing) in the above example embodiments may be stored in a storage device (storage medium), and the functions may be realized with the CPU executing the program stored in the storage device.

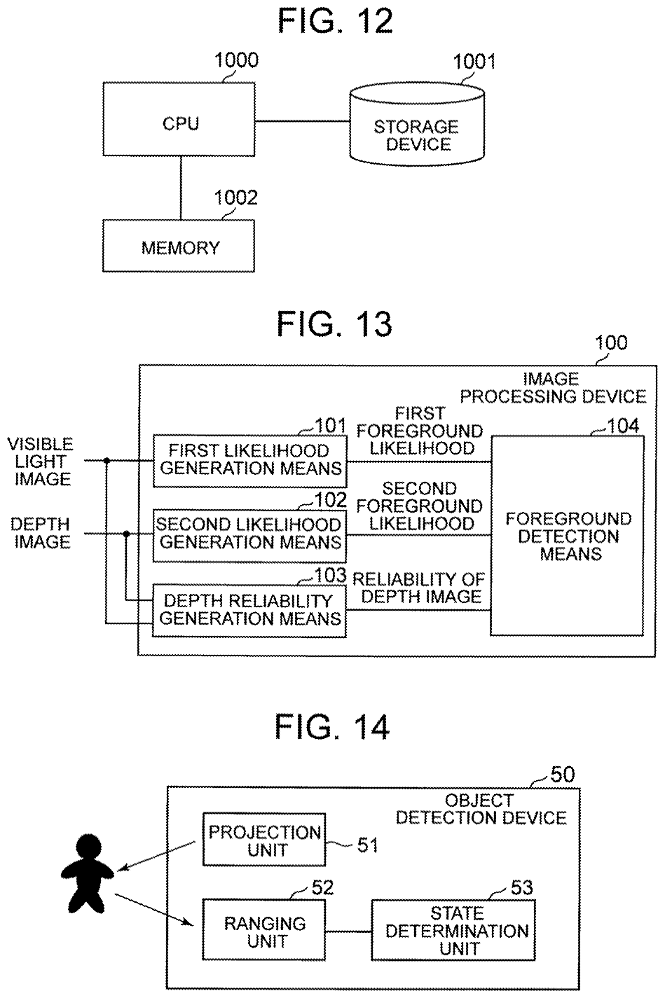

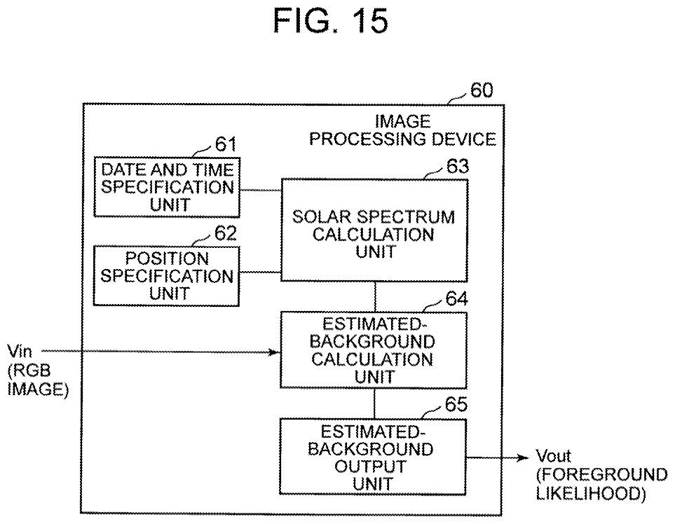

FIG. 12 is a a block diagram showing an example of a computer with a CPU. The computer is implemented in an image processing. The CPU 1000 executes processing in accordance with a program stored in a storage device 1001 to realize the functions in the above example embodiment. That is, the computer realizes the functions of the visible light foreground likelihood generation unit 11, the depth foreground likelihood generation unit 12, the depth reliability generation units 13, 13B, 13C, and the foreground detection unit 14 in the image processing devices 10, 20, and 30 shown in FIGS. 1, 6, and 9.

The storage device 1001 is, for example, a non-transitory computer readable medium. The non-transitory computer readable medium includes various types of tangible storage media. Specific examples of the non-transitory computer readable medium include magnetic storage media (for example, flexible disk, magnetic tape, hard disk drive), magneto-optical storage media (for example, magneto-optical disc), compact disc-read only memory (CD-ROM), compact disc-recordable (CD-R), compact disc-rewritable (CD-R/W), and semiconductor memories (for example, mask ROM, programmable ROM (PROM), erasable PROM (EPROM), flash ROM).

A memory 1002 is a storage means implemented by a random access memory (RAM), for example, and temporarily stores data when the CPU 1000 executes processing. A conceivable mode is that the program held in the storage device 1001 or in a transitory computer readable medium is transferred to the memory 1002, and the CPU 1000 executes processing on the basis of the program in the memory 1002.

The memory 1002 is realized, for example, by RAM (Random Access Memory), and is a storage means for temporarily storing data when the CPU 1000 executes processing. It can be assumed that a program held by the storage device 1001 or a temporary computer readable medium is transferred to the memory 1002, and that the CPU 1000 executes processing based on the program in the memory 1002.

FIG. 13 is a block diagram of the main part of an image processing device. The image processing device 100 shown in FIG. 13 comprises first likelihood generation means 101 (in the example embodiments, realized by the visible light foreground likelihood generation unit 11) for generating first foreground likelihood (for example, the foreground likelihood of the visible light image) from a visible light image, second likelihood generation means 102 (in the example embodiments, realized by the depth foreground likelihood generation unit 12) for generating second foreground likelihood from a depth image in which the same object is captured as that in the visible light image, depth reliability generation means 103 (in the example embodiments, realized by the depth reliability generation unit 13, 13B, 13C) for generating reliability of the depth image using at least the visible light image and the depth image, and foreground detection means 104 (in the example embodiments, realized by the foreground detection unit 14) for determining foreground likelihood of the object based on the first foreground likelihood and the second foreground likelihood, using the reliability of the depth image as a weight.

A part of or all of the above example embodiments may also be described as, but not limited to, the following supplementary notes.

(Supplementary note 1) An image processing method comprising:

generating first foreground likelihood from a visible light image,

generating second foreground likelihood from a depth image in which the same object is captured as that in the visible light image,

generating reliability of the depth image using at least the visible light image and the depth image, and

determining foreground likelihood of the object based on the first foreground likelihood and the second foreground likelihood, using the reliability of the depth image as a weight.

(Supplementary note 2) The image processing method according to Supplementary note 1, wherein

the reliability of the depth image is generated after assigning relatively high reliability to a region where gradient of the observed values in the depth image is less than or equal to a predetermined value.

(Supplementary note 3) The image processing method according to Supplementary note 1 or 2, further comprising:

detecting edges in the depth image, and

detecting edges in the visible light image,

wherein when the edges are detected in a region of the visible light image, the region being equivalent to a region where the edges are detected in the depth image, relatively high reliability is assigned to the region.

(Supplementary note 4) The image processing method according to Supplementary note 1 or 2, further comprising:

detecting edges in the depth image, and

detecting edges in a near infrared image in which the same object is captured as that in the depth image,

wherein when the edges are detected in a region of the near infrared image, the region being equivalent to a region where the edges are detected in the depth image, relatively high reliability is assigned to the region.

(Supplementary note 5) The image processing method according to Supplementary note 1 or 2, further comprising:

detecting edges in the depth image,

detecting edges in the visible light image,

detecting edges in a near infrared image in which the same object is captured as that in the depth image, and

detecting edges in a near infrared image in which the same object is captured as that in the depth image,

wherein when the edges are detected in a region of the visible light image and in a region of the near infrared image, both regions being equivalent to a region where the edges are detected in the depth image, relatively high reliability is assigned to the region.

(Supplementary note 6) The image processing method according to any one of Supplementary notes 1 to 5, further comprising:

assigning lower reliability to a region consisting of distance measurement impossible pixels.

(Supplementary note 7) An image processing device comprising:

first likelihood generation means for generating first foreground likelihood from a visible light image,

second likelihood generation means for generating second foreground likelihood from a depth image in which the same object is captured as that in the visible light image,

depth reliability generation means for generating reliability of the depth image using at least the visible light image and the depth image, and

foreground detection means for determining foreground likelihood of the object based on the first foreground likelihood and the second foreground likelihood, using the reliability of the depth image as a weight.

(Supplementary note 8) The image processing device according to Supplementary note 7, wherein

the depth reliability generation means includes at least an observed value gradient calculation unit which calculates gradient of the observed values in the depth image and a depth reliability determination unit which determines the reliability of the depth image, and

the depth reliability determination unit assigns relatively high reliability to a region where gradient of the observed values in the depth image is less than or equal to a predetermined value.

(Supplementary note 9) The image processing device according to Supplementary note 7 or 8, wherein

the depth reliability generation means includes a first edge detection unit which detects edges in the depth image, a second edge detection unit which detects edges in the visible light image, and a depth reliability determination unit which determines the reliability of the depth image, and

when the edges are detected in a region of the visible light image, the region being equivalent to a region where the edges are detected in the depth image, the depth reliability determination unit assigns relatively high reliability to the region.

(Supplementary note 10) The image processing device according to Supplementary note 7 or 8, wherein

the depth reliability generation means includes a first edge detection unit which detects edges in the depth image, a third edge detection unit which detects edges in a near infrared image in which the same object is captured as that in the depth image, and a depth reliability determination unit which determines the reliability of the depth image, and

when the edges are detected in a region of the near infrared image, the region being equivalent to a region where the edges are detected in the depth image, the depth reliability determination unit assigns relatively high reliability to the region.

(Supplementary note 11) The image processing device according to Supplementary note 7 or 8, wherein

the depth reliability generation means includes a first edge detection unit which detects edges in the depth image, a second edge detection unit which detects edges in the visible light image, a third edge detection unit which detects edges in a near infrared image in which the same object is captured as that in the depth image, and a depth reliability determination unit which determines the reliability of the depth image, and

when the edges are detected in a region of the visible light image and in a region of the near infrared image, both regions being equivalent to a region where the edges are detected in the depth image, the depth reliability determination unit assigns relatively high reliability to the region.

(Supplementary note 12) The image processing device according to any one of Supplementary notes 8 to 11, wherein

the depth reliability generation means includes a distance measurement impossible pixel determination unit which detects distance measurement impossible pixels, and

the depth reliability determination unit assigns lower reliability to a region consisting of the distance measurement impossible pixels.

(Supplementary note 13) An image processing program causing a computer to execute:

a process of generating first foreground likelihood from a visible light image,

a process of generating second foreground likelihood from a depth image in which the same object is captured as that in the visible light image,

a process of generating reliability of the depth image using at least the visible light image and the depth image, and

a process of determining foreground likelihood of the object based on the first foreground likelihood and the second foreground likelihood, using the reliability of the depth image as a weight.

While the present invention has been described above with reference to the example embodiment, the present invention is not limited to the aforementioned example embodiment. Various changes understandable by those skilled in the art within the scope of the present invention can be made for the arrangements and details of the present invention.

### REFERENCE SIGNS LIST

10, 20, 30 image processing device

11 visible light foreground likelihood generation unit

12 depth foreground likelihood generation unit

13, 13B, 13C depth reliability generation unit

14 foreground detection unit

41 visible light camera

42 depth camera

43 near infrared light camera

100 image processing device

101 first likelihood generation means

102 second likelihood generation means

103 depth reliability generation means

104 foreground detection means

131 observed value gradient calculation unit

132 distance measurement impossible pixel determination unit

133 first edge detection unit

134 second edge detection unit

135 third edge detection unit

136 depth reliability determination unit

1000 CPU

1001 storage device

1002 memory

What is claimed is:

1. An image processing method comprising:
generating first foreground likelihood from a visible light image,
generating second foreground likelihood from a depth image in which the same object is captured as that in the visible light image,
generating reliability of the depth image using at least the visible light image and the depth image, and
determining foreground likelihood of the object based on the first foreground likelihood and the second foreground likelihood, using the reliability of the depth image as a weight.

2. The image processing method according to claim 1, wherein
the reliability of the depth image is generated after assigning relatively high reliability to a region where gradient of the observed values in the depth image is less than or equal to a predetermined value.

3. The image processing method according to claim 1, further comprising:
detecting edges in the depth image, and
detecting edges in the visible light image,
wherein when the edges are detected in a region of the visible light image, the region being equivalent to a region where the edges are detected in the depth image, relatively high reliability is assigned to the region.

4. The image processing method according to claim 1, further comprising:
detecting edges in the depth image, and
detecting edges in a near infrared image in which the same object is captured as that in the depth image,
wherein when the edges are detected in a region of the near infrared image, the region being equivalent to a region where the edges are detected in the depth image, relatively high reliability is assigned to the region.

5. The image processing method according to claim 1, further comprising:
detecting edges in the depth image,
detecting edges in the visible light image,
detecting edges in a near infrared image in which the same object is captured as that in the depth image, and
detecting edges in a near infrared image in which the same object is captured as that in the depth image,
wherein when the edges are detected in a region of the visible light image and in a region of the near infrared image, both regions being equivalent to a region where the edges are detected in the depth image, relatively high reliability is assigned to the region.

6. The image processing method according to claim 1, further comprising:
assigning lower reliability to a region consisting of distance measurement impossible pixels.

7. An image processing device comprising:
first likelihood generation means for generating first foreground likelihood from a visible light image,
second likelihood generation means for generating second foreground likelihood from a depth image in which the same object is captured as that in the visible light image,
depth reliability generation means for generating reliability of the depth image using at least the visible light image and the depth image, and
foreground detection means for determining foreground likelihood of the object based on the first foreground likelihood and the second foreground likelihood, using the reliability of the depth image as a weight.

8. The image processing device according to claim 7, wherein
the depth reliability generation means includes at least an observed value gradient calculation unit which calculates gradient of the observed values in the depth image and a depth reliability determination unit which determines the reliability of the depth image, and
the depth reliability determination unit assigns relatively high reliability to a region where gradient of the observed values in the depth image is less than or equal to a predetermined value.

9. The image processing device according to claim 7, wherein
the depth reliability generation means includes a first edge detection unit which detects edges in the depth image, a second edge detection unit which detects edges in the visible light image, and a depth reliability determination unit which determines the reliability of the depth image, and
when the edges are detected in a region of the visible light image, the region being equivalent to a region where the edges are detected in the depth image, the depth reliability determination unit assigns relatively high reliability to the region.

10. The image processing device according to claim 7, wherein
the depth reliability generation means includes a first edge detection unit which detects edges in the depth image, a third edge detection unit which detects edges in a near infrared image in which the same object is captured as that in the depth image, and a depth reliability determination unit which determines the reliability of the depth image, and
when the edges are detected in a region of the near infrared image, the region being equivalent to a region where the edges are detected in the depth image, the depth reliability determination unit assigns relatively high reliability to the region.

11. The image processing device according to claim 7, wherein
the depth reliability generation means includes a first edge detection unit which detects edges in the depth image, a second edge detection unit which detects edges in the visible light image, a third edge detection unit which detects edges in a near infrared image in which the same object is captured as that in the depth image, and a depth reliability determination unit which determines the reliability of the depth image, and
when the edges are detected in a region of the visible light image and in a region of the near infrared image, both regions being equivalent to a region where the edges are detected in the depth image, the depth reliability determination unit assigns relatively high reliability to the region.

12. The image processing device according to claim 8, wherein
the depth reliability generation means includes a distance measurement impossible pixel determination unit which detects distance measurement impossible pixels, and
the depth reliability determination unit assigns lower reliability to a region consisting of the distance measurement impossible pixels.

13. A non-transitory computer readable recording medium storing an image processing program which, when executed by a processor, performs:
generating first foreground likelihood from a visible light image,
generating second foreground likelihood from a depth image in which the same object is captured as that in the visible light image,
generating reliability of the depth image using at least the visible light image and the depth image, and
determining foreground likelihood of the object based on the first foreground likelihood and the second foreground likelihood, using the reliability of the depth image as a weight.
